(19) United States
(12) Patent Application Publication
(10) Pub. No.: US 2005/0128746 A1
(43) Pub. Date: Jun. 16, 2005

(54) Decorative light string with arranged bulb assemblies

(76) Inventor: Hung-Huei Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/731,016

(22) Filed: Dec. 10, 2003

(51) Int. Cl. F21S 13/14

(52) U.S. Cl. 362/252; 362/391; 362/249; 362/396

(57) ABSTRACT

The present invention relates to a decorative light string with arranged bulb assemblies, which includes a main wire connecting with many bulb assemblies thereon. Each bulb assembly is positioned alone the main wire at interval with an arranged direction to display a novel unique decorative effect.

### BACKGROUND OF THE INVENTION

A decorative light string is widely used in this day to display a lighting effect. The conventional light string includes a main electrical wire, which connects with many bulb assemblies thereon. Each bulb assembly is connected with the main wire at interval and is extended outward randomly. Hence, the light string with such bulb assemblies randomly extended is not beautiful in use.

The present invention is to provide a novel decorative light string, which connects with bulb assemblies in an arranged direction that performs a better outlook of the string.

### BRIEF DESCRIPTION OF THE DRAWINGS

The following drawings indicate the character and improvement of the present invention.

FIG. 1 is a perspective view of a part of a decorative light string according to the present invention.

FIG. 2 is a plan view of an embodiment of the decorative light string according to the present invention.

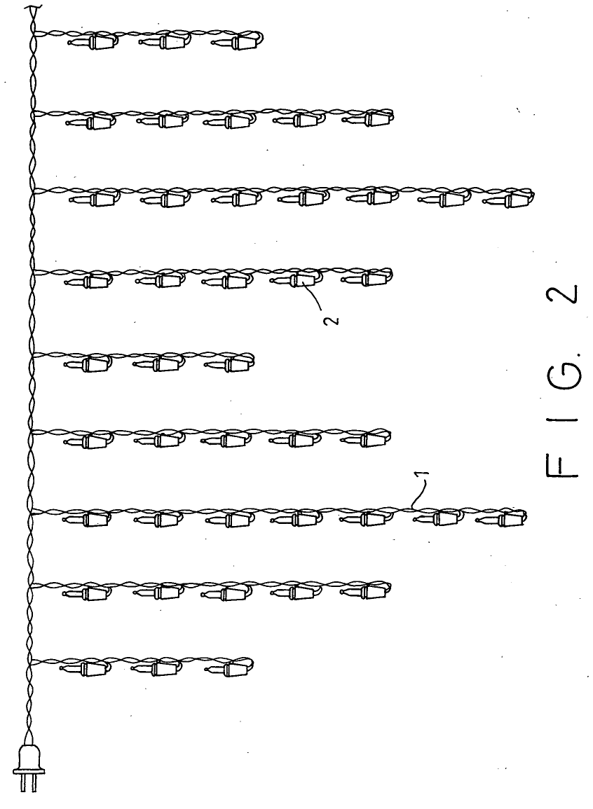

FIG. 3 is a plan view of a further embodiment of the decorative light string according to the present invention.

FIG. 4 is a plan view of another embodiment showing the bulb assembly being connected with the decorative light string according to the present invention.

### DETAILED DESCRIPTION OF THE INVENTION

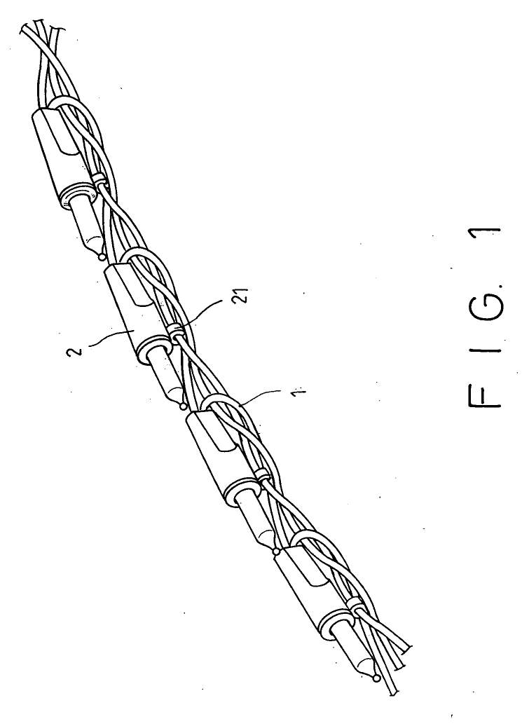

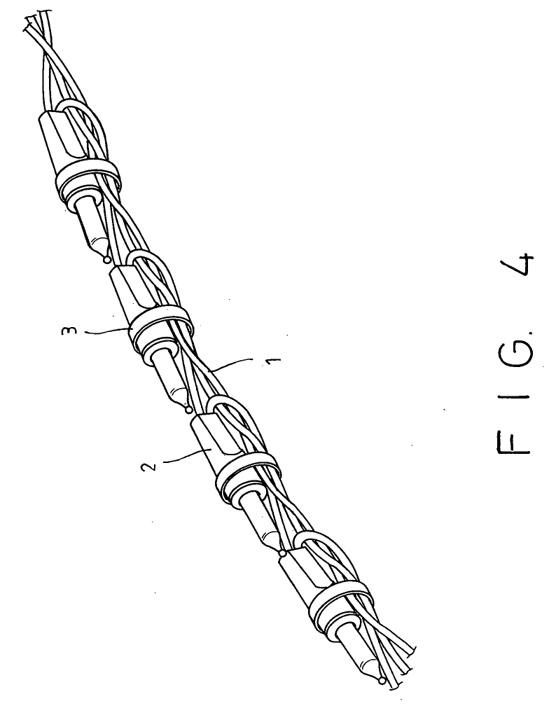

Referring to FIG. 1, it shows an embodiment of a decorative light string, which includes a main wire (1) connecting with many bulb assemblies (2). The improvement of the present invention is that each bulb assembly (2) is arranged and connected with the main wire (1) at the same direction. It is possible to fix the bulb assembly (2) on the wire (1) by a hook (21) formed beside the holder of the bulb assembly (2) to engage with the wire (1). Any other connecting structure can be used to engage the bulb assembly (2) with the wire (1), such as shown in FIG. 4, a ring (3) is provided to position the bulb assembly (2) beside the wire (1) at the same direction firmly.

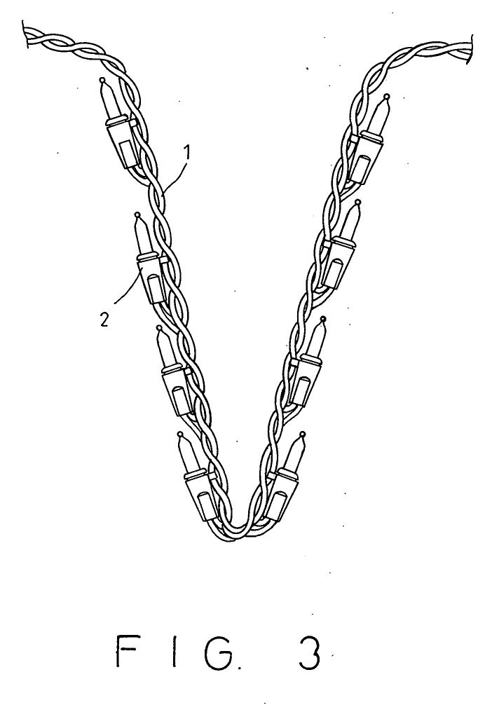

In application, the present invention can be applied on a curtain-type light- string, wherein the bulb assemblies (2) are all arranged at the same direction that shows a perfect decorative effect. It can be understood that any modified structure will be possibly provided and is also claimed in this application, such as the application on a net-type string and so on. Furthermore, FIG. 3 shows another embodiment according to the present invention, wherein the bulb assemblies are divided into two parts being arranged at two respectively directions for providing a similar invented design.

1. A decorative light string with arranged bulb assemblies including a main wire connecting with many bulb assemblies, and the character is that each bulb assembly is engaged with the main wire at an arranged direction.

2. A decorative light string with arranged bulb assemblies as claimed in claim 1, wherein the decorative light string is a curtain-type string, a net-type string, or any decorative string.

3. A decorative light string with arranged bulb assemblies as claimed in claim 1, wherein the bulb assembly is provided with a hook to engage with the main wire.

4. A decorative light string with arranged bulb assemblies as claimed in claim 1, wherein the bulb assembly is positioned alone the main wire by a ring.
